(19) United States
(12) Patent Application Publication
(10) Pub. No.: US 2022/0398934 A1
(43) Pub. Date: Dec. 15, 2022

(54) SYSTEM AND METHODS FOR PROVIDING NETWORK MONITORING AND A CAPTIVE LEARNING PORTAL

(71) Applicant: Joseph M. Anderson, Sanborn, NY (US)

(72) Inventor: Joseph M. Anderson, Sanborn, NY (US)

(21) Appl. No.: 17/841,142

(22) Filed: Jun. 15, 2022

Related U.S. Application Data
(60) Provisional application No. 63/210,682, filed on Jun. 15, 2021.

(51) Int. Cl. G09B 7/00; H04L 9/40; H04L 67/1396

(52) U.S. Cl. CPC G09B 7/00; H04L 63/083; H04L 63/20; H04L 67/1396

(57) ABSTRACT

A system for providing network monitoring and a captive learning portal for a network including a parent device and at least one child devices is provided. The system includes a server providing an authentication system and a learning management system, a gateway device providing a router function and a firewall function. The gateway device connects with the child device and prompts to enter child credentials associated with a child account, communicates with the server to verify the child credentials, and allocate a first time limit to the child account, grants access to the Internet for the child device associated with the child account via the router function in response to successful verification of the child credentials, and blocks access to the Internet for the child device associated with the child account via the firewall function upon said first time limit being reached according to parental control settings for the child account.

### CROSS-REFERENCE TO RELATED APPLICATIONS

This application claims the benefit of U.S. Patent Application No. 63/210,682, filed Jun. 15, 2021, the contents of which are hereby incorporated in its entirety.

### FIELD OF THE INVENTION

The present invention is directed to a system and methods for providing network monitoring and a captive learning portal. In particular, the present invention relates to a system including a local gateway device and one or more remote servers that utilize computer executable instructions for providing an authentication system and a learning management system that allocates time limits for Internet access, and allows more time upon successfully completing a quiz or some other task, according to parental control settings.

### BACKGROUND OF THE INVENTION

Currently, parents must either use a system which they either can strictly limit time on the Internet for their children and decide when or why to turn the Internet back on themselves, physically take away a device, or have high-end technical knowledge of router settings in order to disable individual child devices in the router from being able to access the Internet. Firewalls, learning games, and parental controls exist, but not all in one package, and not in a way which provides a reward wherein a gateway to other websites or applications is closed or opened based on successful completion of a task.

There is a need to create an intermittent learning system and an easier way for parents to manage their children's time online without having to physically take away or deactivate devices from the Internet. There is a need to provide a mechanism that can limit and allocate more time usage for accessing the Internet or specific websites or applications to a child device based on completing tasks. There is also a need for a system that includes a built-in captive learning portal which gives the child the ability to unlock further Internet usage time themselves by successfully completing various tasks, and which allow parents to automatically lock and unlock Internet access for children based on pre-determined variables to allow further access, rather than requiring parents to manually block and unblock each child device on a regular basis.

### SUMMARY OF THE INVENTION

In order to address these and other needs, the present invention provides a system and methods for providing monitoring of a network and a captive learning portal, wherein the network is in communication with an Internet. In particular, the present invention relates to a system including a local gateway device and at least one server (e.g., an authentication server and a learning management server) that utilize computer executable instructions for providing an authentication system and a learning management system that allocates time limits for Internet access, and allows more time upon successfully completing at least one quiz or some other task, according to parental control settings. The gateway device and the server(s) collectively provide the network (also referred to as the Mind-XL network) for at least one parent computing device and child computing device. The servers may consistently update the gateway device with known educational and non-educational IP addresses. The server may house a web application quiz infrastructure to determine appropriate quiz for each child. A local API for full parental controls can trigger individual Internet shutdown for child computing devices and ad-hoc quizzes.

Child computing devices connect to the network as they would any wireless network, except they connect through the gateway device instead of the normal Wi-Fi router. On the other hand, parent computing devices are connected through the normal Wi-Fi router, but can also categorize child computing devices connected to the network into groups. So Child 1's gaming system and cell phone can be grouped so both devices are disabled from Internet until Child 1 navigates to a shortlink to answer a quiz.

When a child exceeds his or her allocated time to access the rest of the Internet (known non-educational IP addresses), the gateway device blocks the ability to access external IP addresses with the exception of IP addresses of the servers in the system (and/or a local Mind-XL IP address of the gateway device). Quizzes are housed on the servers and accessible via a shortlink sent by the servers to the child computing devices via the local gateway device. Once the child answers the quiz with a score threshold met, additional time is allocated to the child and the firewall function of the gateway device unlocks access to the external IP addresses for the child computing device.

According to one aspect of the present invention, a system for providing monitoring of a network and a captive learning portal, wherein the network is in communication with the Internet, is provided. The system may include a parent computing device and/or at least one child computing device. The system includes at least one server configured to provide an authentication system and a learning management system for the parent computing device and the at least one child computing device, and a gateway device configured to provide a router function and a firewall function for the network. The gateway device connects with the child computing device and prompts to enter child credentials associated with a child account, communicates with the at least one server to verify the child credentials associated with the child account, and allocate a first time limit to the child account, and grants access to the Internet for the child computing device associated with the child account via the router function in response to successful verification of the child credentials. The gateway device also blocks access to the Internet for the child computing device associated with the child account via the firewall function upon said first time limit allocated to the child account being reached according to parental control settings for the child account.

In another aspect, the at least one server includes an authentication server configured to verify that the entered child credentials are associated with a valid child account by confirming a password or a PIN of the entered child credentials using a database.

In another aspect, the parental control settings include at least one of: one or more time limits for accessing the Internet using the child computing device associated with the child account; or one or more quiz or task settings for granting more Internet access time for the child computing device associated with the child account.

In another aspect, the at least one server includes a learning management server configured to store at least one qui and task, and provide one or more of the at least one quiz and task to the child computing device via the gateway device after each of the one or more time limits expire according to the parental control settings for the child account.

In another aspect, when the gateway device blocks access to the Internet for the child computing device associated with the child account once said first time limit has been reached, the gateway device communicates with the learning management server to retrieve at least one quiz or task, and communicates with the child computing device to present the at least one quiz or task, wherein in response to results of the quiz reaching a threshold passing score or the task being completed, the gateway device further communicates with the authentication server to allocate a second time limit to the child account, and grants access to the Internet for the child computing device associated with the child account until the second time limit expires.

In another aspect, the gateway device communicates with the at least one server to provide one or more updates to the system based on the results of the at least one quiz or completion of the task, wherein the one or more updates include recording test results, monitoring Internet activity and/or application usage logs, updating scoring leaderboards, adding more time to the child account, editing databases or combinations thereof.

According to another aspect of the present invention, a system for providing monitoring of a network and a captive learning portal, wherein the network is on communication with an Internet. The network includes a parent computing device and/or at least one child computing device. The system includes at least one server configured to provide an authentication system and a learning management system for the at least one parent computing device and the child computing device, and a gateway device configured to provide a router function and a firewall function for the network. The gateway device connects with the parent computing device and prompts to enter parent credentials associated with a parent account, communicates with the at least one server to verify the parent credentials associated with the parent account, and grants access to the learning management system for the parent computing device associated with the parent account via the router function in response to successful verification of the parent credentials. The access enables the parent computing device to configure or modify one or more parental control settings for a selected child account, including setting one or more time limits for accessing the Internet using the at least one child computing device associated with the selected child account.

In another aspect, the at least one server includes an authentication server configured to verify that the entered parent credentials are associated with a valid parent account by confirming a password or a PIN of the entered parent credentials using a database.

In another aspect, configuring or modifying the one or more parental control settings for the selected child account further includes configuring one or more quiz or task settings for granting more Internet access time for the one or more child computing devices associated with the selected child account.

In another aspect, the at least one server includes a learning management server configured to store at least one quiz or task, and provide the at least one quiz and task to the child computing device via the gateway device after each of the one or more time limits expire according to the parental control settings for the selected child account.

In another aspect, the step of configuring the one or more quiz or task settings for the selected child account includes one or more of selecting a difficulty level of quizzes for the selected child account, selecting one or more subjects, topics, or categories of quizzes for the selected child account, setting a total number of questions or problems per quiz for the selected child account, setting a threshold passing score for quizzes for the selected child accounts, selecting one or more predefined quizzes or tasks from one or more lists for the selected child account, wherein the one or more lists are stored by the learning management server, or defining one or more custom quizzes or tasks for the selected child account.

In another aspect, access further enables the parent computing device to save the one or more parental control settings for the selected child account to the at least one server via the gateway device.

According to a further aspect of the present invention, a method programmed for execution in a computing environment for providing monitoring of a network and a captive learning portal for the network, wherein the network is in communication with the Internet. The system may include a parent computing device and at least one child computing device, each having a processor. The method includes connecting with the child computing device and prompting to enter child credentials associated with a child account, communicating with at least one server, which provides an authentication system and a learning management system for the parent computing device and the child computing device, to verify the child credentials associated with the child account, and allocate a first time limit to the child account, and granting access to the Internet for the child computing device associated with the child account via a router function of a gateway device in response to successful verification of the child credentials by the authentication system. The method further includes blocking access to the Internet for the child computing device associated with the child account via a firewall function of the gateway device upon said first time limit allocated to the child account being reached according to parental control settings for the child account.

In another aspect, the parental control settings include at least one of: one or more time limits for accessing the Internet using the child computing device associated with the child account; or one or more quiz or task settings for granting more Internet access time for the child computing device associated with the child account.

In another aspect, the at least one server includes a learning management server configured to store at least one quiz and/or tasks, and provide the at least one quiz and task to the child computing device after each of the one or more time limits expire according to the parental control settings for the child account. In another aspect, when access to the Internet for the child computing device associated with the child account is blocked once said first time limit has been reached, the method further includes communicating with the learning management server to retrieve the at least one quiz or task, and communicating with the child computing device to present the at least one quiz or task. In response to results of the quiz reaching a threshold passing score or the task being completed, the method further includes allocating a second time limit to the child account, and granting access to the Internet for the child computing device associated with the child account until the second time limit expires.

In another aspect, the method further includes communicating with the at least one server to provide one or more updates to the system based on the results of the quiz or completion of the task, wherein the one or more updates include recording test results, monitoring Internet activity and/or application usage logs, updating scoring leaderboards, adding more time to the child account, editing databases or combinations thereof.

According to further aspect of the present invention, a method programmed for execution in a computing environment for providing monitoring of a network and a captive learning portal for the network including a parent computing device and at least one child computing devices, is provided. Utilizing a processor, the method includes connecting with the parent computing device and prompting to enter parent credentials associated with a parent account; communicating with at least one server, which provides an authentication system and a learning management system for the parent computing device and the at least one child computing device, to verify the parent credentials associated with the parent account; and granting access to the learning management system for the parent computing device associated with the parent account via the router function in response to successful verification of the parent credentials by the authentication system. The access enables the parent computing device to configure or modify one or more parental control settings for a selected child account, including setting one or more time limits for accessing the Internet using the at least one child computing device associated with the selected child account.

In another aspect, configuring or modifying the one or more parental control settings for the selected child account further includes configuring quiz or task settings for granting more Internet access time for the at least one child computing device associated with the selected child account.

In another aspect, the at least one server includes a learning management server configured to store the at least one quiz and/or task, and provide the at least one quiz and/or task to the at least one child computing device after each of the one or more time limits expire according to the parental control settings for the selected child account.

In another aspect, the configuring the quiz or task settings for the selected child account includes one or more of selecting a difficulty level of the at least one quiz for the selected child account, selecting one or more subjects, topics, or categories of the at least one quiz for the selected child account, setting a total number of questions or problems for each of the at least one quiz for the selected child account, setting a threshold passing score for the at least one quiz for the selected child account, selecting at least one predefined quiz or task from one or more lists for the selected child account, wherein the one or more lists are stored by the learning management server, or defining at least one custom quiz or task for the selected child account.

In another aspect, the access further enables the parent computing device to save the one or more parental control settings for the selected child account to the at least one server.

Additional benefits of the above-described system and methods for providing network monitoring and a captive learning portal are set forth in the following discussion.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawings, wherein:

FIG. 1 is a schematic diagram showing an exemplary system, including a local gateway device and one or more remote servers, for providing network monitoring and a captive learning portal, according to some example embodiments;

FIG. 2 is a diagram showing a flow of communications with the gateway device and an authentication server of the system, according to some example embodiments;

FIG. 3 shows a captive learning portal flow for a parent computing device, according to an example embodiment;

FIG. 4 shows a captive learning portal flow for a child computing device, according to an example embodiment;

FIG. 5 illustrates a flowchart of a method for providing network monitoring and a captive learning portal from the perspective of a parent computing device of the system, according to some example embodiments;

FIG. 6 illustrates a flowchart of a method for providing network monitoring and a captive learning portal from the perspective of a child computing device of the system, according to some example embodiments; and

FIG. 7 is a block diagram generally illustrating a computing environment in which the system and methods may be implemented.

### DETAILED DESCRIPTION OF THE INVENTION

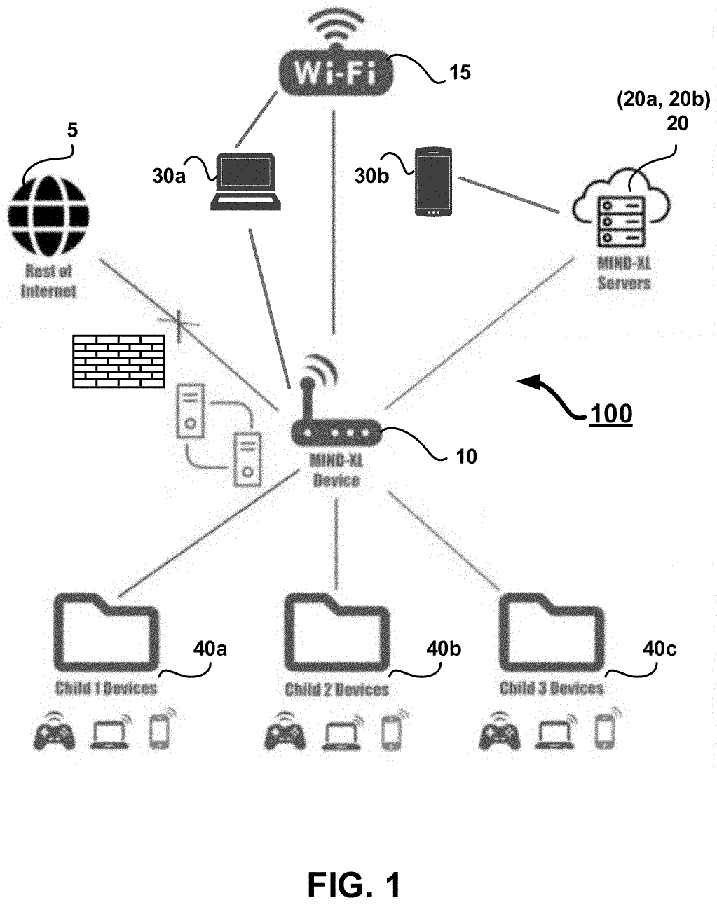

Referring to the drawings in detail, with particular reference to FIG. 1, an aspect of the present invention includes a system 100 that may be used to implement methods for providing network monitoring and a captive learning portal. Other aspects of the present invention will be discussed in more detail below.

As best seen in FIG. 1, system 100 may include one or more computing devices, at least some of which are in communication with a network 5 (e.g., the Internet) via a wired connection or a wireless connection. The computing devices in system 100 that have connections to network 5 include user computing devices, such as one or more parent device 30 (e.g., 30a, 30b) and one or more child device 40 (e.g., child devices 40a of child 1, child devices 40b of child 2, child devices 40c of child 3, etc.). Each of user computing devices 30 and 40, a gateway device 10, and one or more servers 20 (“server”) may include a processor and a memory, which may have various programs, applications, logic, algorithms, instructions, stored therein. As such, the system and methods described herein are not limited to any specific hardware or software configuration, but may rather be implemented as computer executable instructions in any computing or processing environment, including in digital electronic circuitry or in computer hardware, firmware, device driver, or software. For example, user computing devices 30 and 40 may be mobile computing devices (e.g., smartphones or tablets), portable computers (e.g., laptops), stationary computers (e.g., desktop PCs), or various other similarly configured electronic devices including processors, memories, and network connectivity. One or more gateway device 10, server 20, and/or user computing devices 30, 40 may be programmed with computer executable instructions for providing network monitoring and a captive learning portal as described herein. Although two parent devices 30 and three sets of child devices 40 are shown in FIG. 1, it should be understood that this is illustrative only and system 100 may include any number of user computing devices.

User computing devices 30, 40 may be configured to download or otherwise access at least one application (“application”) via network 5. Among various other features and functions, the application enables users to access an authentication system and a learning management system provided by server 20 according to example embodiments described herein. The application may be a mobile application (“App”) or client desktop application, for example. The application may be stored on and obtained from server 20 in some example embodiments, or a dedicated App store (e.g., APPLE, ANDROID, WINDOWS, etc.) as known in the art. The application may also be a web-based application that is accessed using a web browser, for example. In addition, server 20 may also store data or other information that are communicated from user computing devices 30, 40 via gateway device 10 and network 5. Accordingly, server 20 may provide various services, including but not limited to an authentication service and a learning management service, to users (parents and children) of computing devices 30 and 40. Although there may be a single server 20 in system 100 of FIG. 1, there could be multiple separate and distinct servers for different applications or for performing different functions, such as an authentication server 20a and a learning management system server 20b, for example.

According to an aspect of the present invention, as shown in FIG. 1, system 100 for providing network monitoring and a captive learning portal may comprise a local gateway device 10 (e.g., Mind-XL Firewall/Router) and remote server 20 having one or more corresponding applications. In some example embodiments, server 20 may include different types of web servers such as authentication server 20a (e.g., Mind-XL authorization server) and learning management server 20b (e.g., Mind-XL captive learning portal), which may be implemented on the same computing device or separate computing devices. Various functions of the applications may include, but are not limited to, parental control settings, credential authentication and authorization, and administration of quizzes or other tasks in an educational yet game-like manner. Although functions of authentication server 20a and learning management server 20b may be combined, it should be appreciated that maintaining separate databases for each of these functions may be more efficient and would allow easier integration for multiple uses of the learning management system. Gateway device 10 acts as an intermediary device between authentication server 20a and learning management server 20b. Gateway device 10 is a firewall between the rest of Internet 5 and child device 40, as well as a route to the captive learning portal. Therefore, gateway device 10 provides functions to interact with authentication server 20a and learning management server 20b, while also providing parent users with the ability to limit Internet usage for child users. For example, gateway device 10 can successfully shut off Internet access programmatically.

According to another aspect of the present invention, system 100 of FIG. 1 further includes one or more parent device 30, and one or more child device 40. In one non-limiting example embodiment shown in FIG. 1, child device 40 may include a first set of child devices (child 1 devices 40a), a second set of child devices (child 2 devices 40b), and a third set of child devices (child 3 devices 40c), although different numbers of children and corresponding child devices are also possible and contemplated within the scope of the disclosure set forth herein. Examples of child device 40 may include, but are not limited to, gaming systems, smartphones, desktop and laptop computers, tablets, and other mobile devices with Internet access capabilities. In some example embodiments, parent device 30 may store or access a parent application 32 and child device 40 may store or access a child application 42 in order to implement the various functionality described herein, respectively. Non-limiting examples of parent device 30 may include a computer (desktop or laptop) or mobile device (e.g., smartphone or tablet).

Authentication server 20a provides a service that enables authentication between user devices 30, 40 and system 100 itself, and determines for how long a child account will have access to Internet 5. Authentication server 20a will also store the limitations to apply to child accounts, based on parental controls. Providing remote authentication server 20a, instead of requiring everything to be done locally including parental controls, has the advantage of allowing for a smaller storage and lower cost for local gateway device 10. However, it should be appreciated that in some other example embodiments, the core system could be changed to successfully accomplish the authentication task and parental controls locally, along with periodic updates being launched to populate local gateway device 10 with new data.

Learning management server 20b (also referred to as a captive learning portal herein) provides a learning management system which is populated with the learning application itself. In some example embodiments, learning management server 20b can also be populated with local quizzes or tasks that are created by users (e.g., parents) for use only with their personal accounts (e.g., for their own children).

It should also be appreciated that system 100 and applications 32, 42 may function without learning management server 20b, essentially turning gateway device 10 purely into a parental controls system to limit Internet usage times for their children, which is implemented based on various selectable presets or customizable settings, without any educational or child engagement component. Likewise, system 100 and applications 32, 42 could be used strictly as a learning management system to present various quizzes or tasks, with no parental controls or firewall functionality.

Gateway device 10 allows child device 40 to connect to gateway device 10 as they would in the case of a typical wireless network router 15. By contrast, parent device 30 is able to connect to an open API to local gateway device 10 by tethering in through the local Wi-Fi network, connect via a web application on the cloud which syncs with local gateway device 10, or login directly via local gateway device 10 and a PIN or password (e.g., parent PIN 35). Parent device 30 may be connected to normal Wi-Fi router 15, but can categorize child device 40 that are connected to gateway device 10 via gateway device 10. So child 1's gaming system, computer, and smartphone can be grouped such that all of these child devices 40a of child 1 are disabled from Internet access until child 1 navigates to gateway device 10 to answer a quiz from learning management server 20b, via child application 42. Similar groupings of devices can also be made for child 2 (child devices 40b) and child 3 (child devices 40c), etc. Parents are able to use parent device 30 to set time limits on internet usage for child accounts, monitor Internet usage by each account, as well as create or choose pre-made interactive learning experiences for the child accounts to solve in order to add more internet usage time to the child account, via parent application 32.

Gateway device 10 reaches out to authentication server 20a to retrieve and allocate time to the child account. Upon a child account reaching their Internet usage time limit, gateway device 10 will act as a firewall blocking all access to the rest of Internet 5, besides web server 20 (e.g., authentication server 20a and learning management server 20b). Gateway device 10 reaches out to learning management server 20b to retrieve a quiz or task. Upon successful completion, gateway device 10 reaches out to authentication server 20a again to allocate more time to the child account, and access to the rest of Internet 5 is then unlocked for that amount of time for child device 40. Therefore, system 100 is configured to generate (retrieve for display) a “quiz” or task (such as via an app, text, or device notification) in which the child must navigate to in order to solve questions designed to engage and educate the child. A quiz may be in the form of one or more questions or problems with one or more corresponding correct answers or solutions. A task may relate to various different household chores commonly performed by children at the request of their parents.

Accordingly, system 100 with the functionality of gateway device 10 and server 20 as described herein is meant to limit Internet usage of connected child accounts and create a captive learning portal to allow the child to unlock rewards in the form of more Internet usage time. System 100 is also meant to gamify learning by rewarding children in a point-based system in which they can redeem those points, as well as compete with others using the system in the same network, community, or even across the entire world of other users. An additional scope of the present invention may include gamifying system 100, such as by creating leaderboards as well as a rewards bank.

The learning web application itself will have a variety of settings, but for the sake of simplicity, one non-limiting illustrative example is that the child just needs to solve a quiz of four questions with at least three correct answers (e.g., minimum “threshold” score of 75%) to unblock access to the rest of Internet 5 for another allocated amount of time set by the parents via parent device 30. However, it should be appreciated that the total number of questions and the required number of correct answers in order to successfully pass the quiz and thereby obtain additional internet usage time, may be different and are user adjustable as needed so that the parents can adapt specific parental control settings for each child at any time.

In some example embodiments, the same types of quizzes or tasks, the same numbers of questions, and/or the same threshold passing score may be applied for all child devices 40, such as according to default settings of the learning web application or customized presets created via parent device 20. In some other example embodiments, parents can use parent device 20 to configure different types of quizzes or tasks, different numbers of questions, and/or different threshold passing scores for different groups of child devices 40 (e.g., younger children vs. older children, etc.) and/or each individual child device 40a, 40b, 40c, etc. This aspect of configuring system 100 can help to account for different ages, skill levels, comprehension ability, intelligence levels, rewards, and the like on a per child basis or per group basis.

According to yet another aspect, gateway device 10 of system 100 may be consistently or periodically updated with various information or data via the one or more server 20a and/or 20b, such as lists of known bad IP addresses to permanently block, as well as lists of known good educational IP addresses (e.g., Google, Wikipedia, Zoom, etc.) that can remain unblocked, and/or non-educational IP addresses (e.g., INSTAGRAM, FACEBOOK, TWITTER, TIKTOK, etc.) that can be selectively blocked and unblocked.

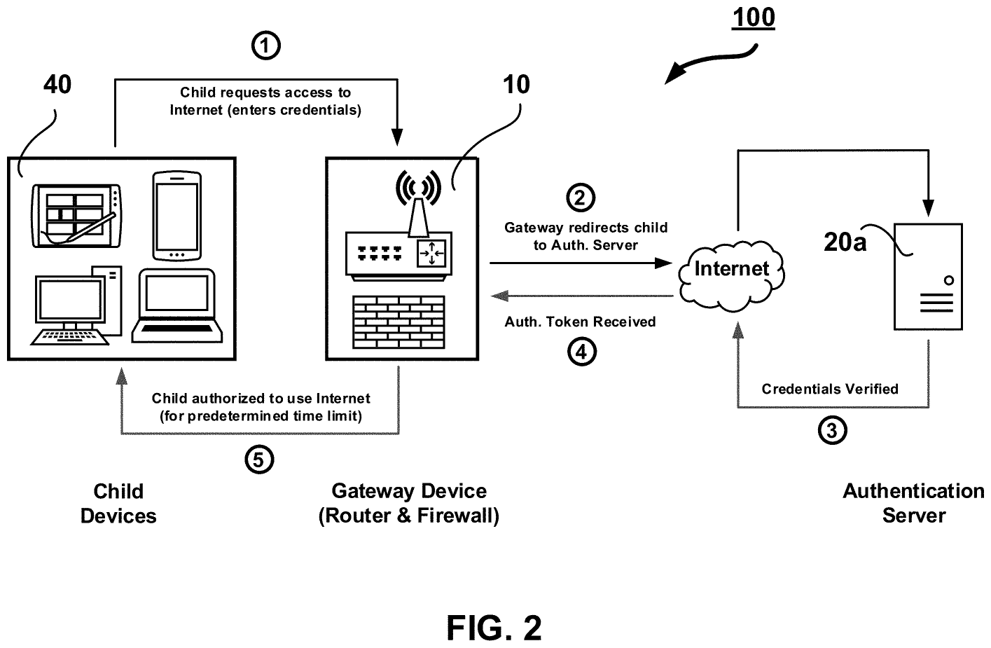

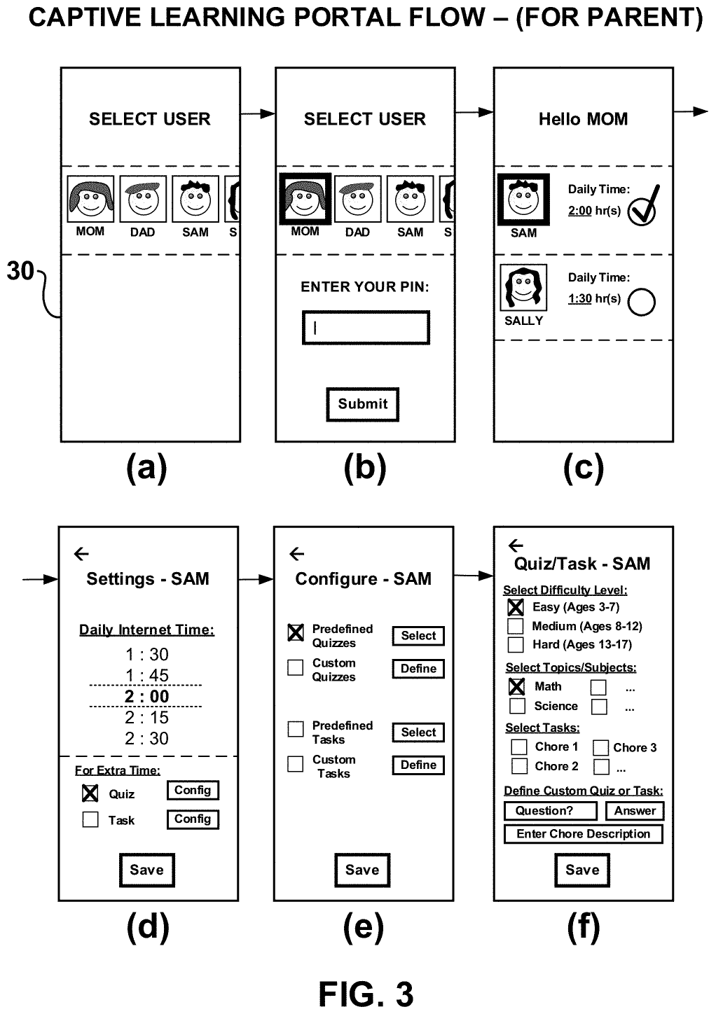

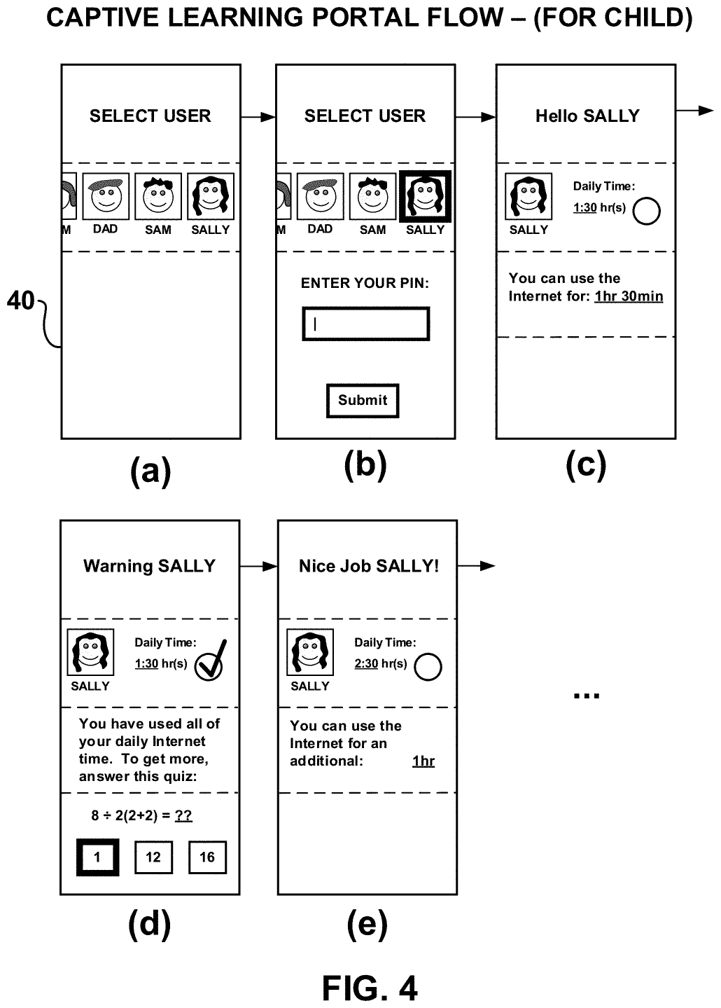

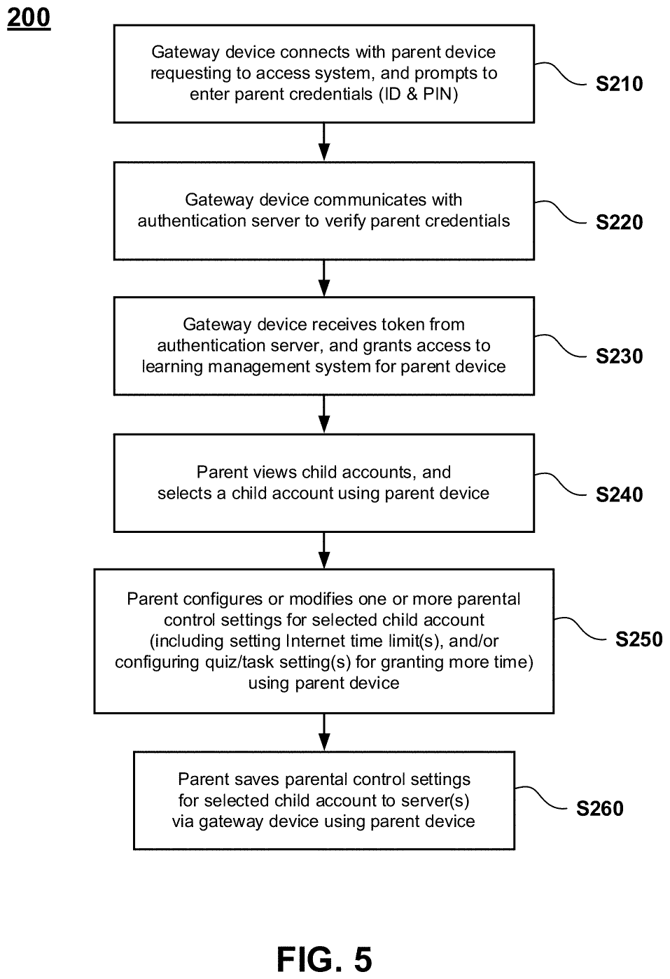

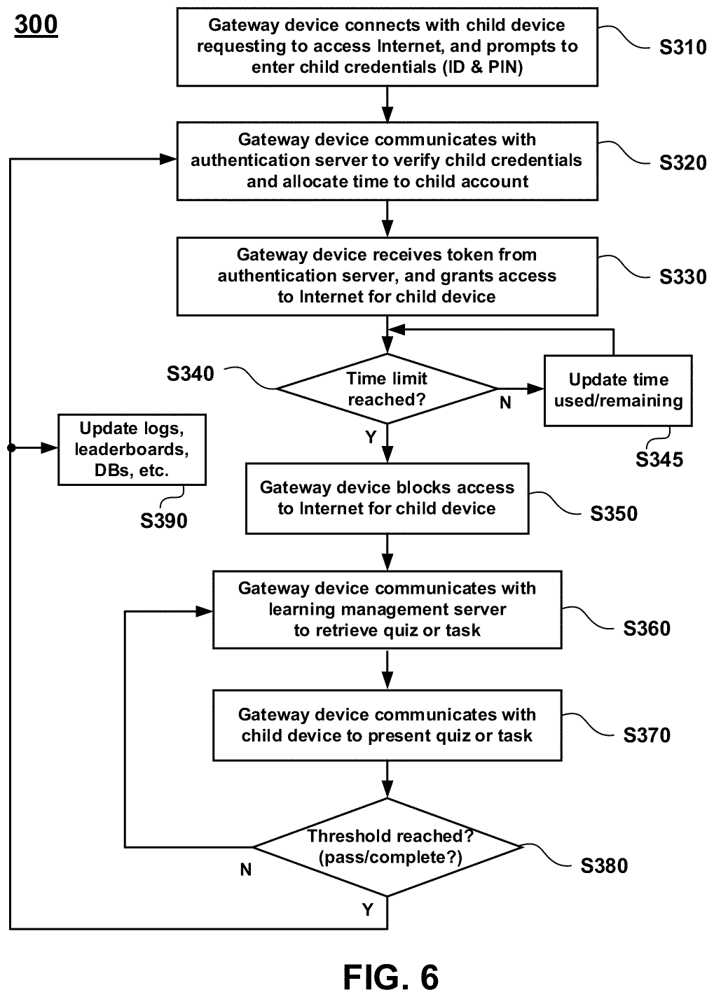

Next, an exemplary procedure for utilizing system 100 for providing network monitoring will be described with reference to the diagram shown in FIG. 2. Then, two different variations of the exemplary method will be described with reference to the flowcharts showing method 200 in FIGS. 3 and 5 (parent device use-case scenario) and method 300 in FIGS. 4 and 6 (child device use-case scenario), respectively.

Now referring to FIG. 2, some example embodiments of system 100 utilize an authentication server and account based login (e.g., using a unique ID and PIN or password assigned to each child device 40). As shown in FIG. 2, the core technologies used will be gateway device 10 (e.g., an OpenWRT router) along with authentication server 20a (e.g., a WifiDog web authentication and authorization server) to act as the gateway between child device 40 and access to the rest of Internet 5. Each time a child wants to login to gain Internet access, the child is required to select their account (or input their corresponding ID) using a software application (e.g., child application 42) on their child device 40 and enter their PIN or password (e.g., child PIN 45) to login, whereby gateway 10 communicates with authentication server 20a to verify the child account and allocate time limits for Internet access.

The flow of communications illustrated in FIG. 2 is as follows: (1) child device 40 (e.g., 40a, 40b, 40c, etc.) requests Internet access, (2) gateway 10 redirects child user to authentication server 20a, (3) authentication server 20a verifies child credentials (e.g., child ID and child PIN/password 45) associated with a child account and issues an authentication token 25a, and (4) gateway 10 receives authentication token 25a and authorizes user device 40 to access the rest of Internet 5, until a predetermined time limit has elapsed. As mentioned above, parents can adjust time limits for all child devices, certain subsets of child devices, and/or and any individual child device using a software application (parent application 32) on their parent device 30.

FIG. 3 shows an example flow of the captive learning portal provided via learning management server 20b from the perspective of a parent via parent application 32 and parent device 30. As shown in FIG. 3, a series of graphical user interface screens that may be shown on parent device 30 during this captive portal flow process include: (a) a user selection screen, which could be a slider bar with user names and corresponding photos or avatars (or alternatively, a drop down menu or a simple list of users), (b) an enter password screen for the selected parent user (e.g., Mom), (c) a child time screen where the parent can see how much Internet access time each child has and whether or not each child has used up all of their allocated time limit, as well as select a child account to configure various parental control settings for that child (e.g., Sam), and (d) a parental control settings screen where the parent can set a daily Internet time limit for that child, add a condition for gaining extra Internet access time for that child, and save these parental control settings. One or more additional screens may also be presented to allow the parent to drill down into further details of configuring the parental control settings for each child account.

For example, the series of GUI screens in FIG. 3 may further include: (e) a configuration screen where the parent can select predefined quizzes, custom quizzes, predefined tasks, custom tasks or combinations thereof, and save these parental control settings, and (f) a quiz/task screen where the parent can select a difficulty levels, select one or more topics or subjects for the quizzes from a list of categories, select one or more specific tasks or chores from a list of chores, or define a custom quiz (question/problem with corresponding answer/solution) or a custom task (chore description), and save these parental control settings. Although not shown in FIG. 3, one of these exemplary GUI screens or one or more additional GUI screens could also be presented on parent device 30 to allow the parent to select or modify a number of questions/problems per quiz, to select or modify a threshold passing score for the quizzes for each child account, and/or to select or modify extra time limits that will be allocated to the child account each time quiz is passed or a task is completed successfully. Although six GUI screens are shown in the exemplary captive portal flow of FIG. 3, this is not intended to be limiting and a greater or fewer number of screens may be shown, whereby certain aspects may be combined into a single screen or split up across multiple different screens.

FIG. 4 shows an example flow of the captive learning portal provided via learning management server 20b from the perspective of a child (e.g., child 1, child 2, child 3, etc.) via child application 42 and child device 40 (e.g., 40a, 40b, 40c, etc.). As shown in FIG. 3, a series of graphical user interface screens that may be shown on child device 40 during this captive portal flow process include: (a) a user selection screen, which could be a slider bar with user names and corresponding photos or avatars (or alternatively, a drop down menu or a simple list of users), (b) an enter password screen for the selected child user (e.g., Sally), (c) a child time screen where the child can see how much Internet access time he or she has and whether or not that child has used up all of their allocated time limit. Once the child has reached their allocated time limit, one or more additional screens may also be presented to allow the child to obtain more Internet access time by completing a quiz or task.

For example, the series of GUI screens in FIG. 4 may further include: (d) a warning screen that indicates the child has used all of their allocated time limit, and indicates that the child can answer a quiz (or complete a task) in order to obtain additional Internet access time, and (e) a result screen that may congratulate the child on successfully passing the quiz (or completing the task) and indicate the amount of additional Internet time that has been allocated to the child account in response thereto. Although not shown in FIG. 4, in the event that the child does not pass the quiz (e.g., score below threshold), child device 40 may allow the child to retry again by taking another quiz. Although one question/problem is shown in FIG. 4, there may be a list of multiple questions/problems shown at the same time, or the warning screen may be dynamically updated with each question/problem of the quiz as the child submits each of their answers/solutions. As described above, the quiz (or task, or individual questions/problems of each quiz) could be automatically selected at random from a predetermined list, manually selected by the parent as desired, or even custom made by the parent for their children. In some example embodiments, this process can be repeated indefinitely each time the child runs out of Internet access time in a given time period (e.g., day, week, etc.), or alternatively, repeated only a certain number of times up to some predefined maximum for that time period according to the parental control settings. Although five GUI screens are shown in the exemplary captive portal flow of FIG. 4, this is not intended to be limiting and a greater or fewer number of screens may be shown, whereby certain aspects may be combined into a single screen or split up across multiple different screens.

Although example embodiments described above with reference to FIGS. 2-4 relate to using an authentication and account based login technology, whereby open source projects provide an already established way of limiting Internet through authentication (much like an airport, for example), it should be appreciated that the present invention is not limited thereto.

An alternative example embodiment of gateway device 10 of system 100 of FIG. 1 may be configured to limit access to Internet 5 for child device 40 using basic IPtables and a mini PC with a unix based system to locally block MAC addresses of child devices 40 from accessing IP addresses outside of the web server 20 by using shell scripts once time limits are reached for said MAC addresses. IPtables can also be used to limit access to certain websites, such as via custom code installed on an OpenWRT LINUX based system. System 100 and its functions can be accomplished (while cutting out WiFi Dog and OpenWRT) by writing completely custom tasks on a LINUX based router. Some other pre-built firewall could also be used to programmatically block IPs for devices or accounts all stored on the local gateway device 10 itself.

Thus, it is contemplated that OpenWRT can be installed on a Ruby PI or other OpenWRT based system to accomplish the processes described above, if desired. However, some drawbacks are that these alternative examples would require more work, would increase the basic hardware needs of gateway device 10, and may provide a less reliable way of wireless connectivity, as compared to the cloud-based system described above with reference to FIG. 2 which can provide households with many devices connecting to Wi-Fi with a more reliable connection.

In either case, the core of system 100 described above with reference to FIGS. 1-4 and corresponding methods described below with reference to FIGS. 5-6 is to provide strong parental controls and implement a full-scale learning management system that administers intermittent learning by rewarding child users with more Internet access time.

FIG. 5 illustrates a flowchart of a method 200 for providing network monitoring and a captive learning portal from the perspective of a parent device 30 of the system, according to some example embodiments. Also refer to the captive learning portal flow for the parent device of FIG. 3.

Initially, gateway device 10 connects with parent device 30, at step S210. This may include one or more GUI screens prompting the parent for their credentials (select or enter their parent ID and enter their parent PIN/password). A parent may have previously performed initial setup of system 100 for use in their home network, such as by registering their parent device 30 and parent credentials (parent ID and parent PIN/password) with an associated parent account, and by registering their child device 40 and child credentials (IDs and PINs/passwords) with associated child accounts. Parents can use their parent device 30 to communicate with authentication server 20a, via gateway device 10, to perform this initial registration process. It should also be appreciated that various parental control settings may be automatically pre-selected by default or manually pre-selected by one of the parents, and these parental control settings are editable/configurable by the parents for a group of children or each child individually.

At step S220, gateway device 10 communicates with authentication server 20a to verify parent account associated with parent credentials. In response to successful verification of parent credentials by authentication server 20a, gateway device 10 receives an authentication token issued by authentication server 20a, and gateway device 10 grants access to learning management server 20b for parent device using the token, at step S230.

With this access, parent device 40 can display the child accounts so the parent can view associated information, each of their allocated time limits, and whether or not they have used all of their Internet time for a given time period (e.g., daily). At step S240, the parent can also select one of the child accounts using parent device 30, so that the parent can configure or modify various parental control settings for that child and their corresponding child device 40, at step S250. The current parental control settings may be automatically pre-selected by default or manually pre-selected by the parent, and they may also be user adjustable and customizable. Parent device 40 can also be used to save these parental control settings on server 20 (e.g., learning management server 20b and/or authentication server 20a) via gateway device 10.

For example, the parental control settings may include, but are not limited to: setting Internet time limit(s) for the child account (e.g., a first time limit, a second time limit after passing a quiz or completing a task, a maximum total daily limit, etc.); setting a manner in which the child can obtain extra time (e.g., successfully complete a quiz and/or perform a task); selecting whether predefined quizzes custom quizzes, predefined tasks, custom tasks or combinations thereof will be presented for the child account; selecting a difficulty level (e.g., easy, medium, hard, depending on ages and abilities) of the quizzes for the child account; selecting one or more topics/subjects/categories for the quizzes; setting a total number of questions/problems per quiz; setting a threshold passing score for the child account; selecting one or more specific tasks (e.g., chores to be performed by the child); and/or defining custom quizzes (enter question/problem and corresponding answer/solution) or tasks (describe a new chore). Various other parental control settings or certain modifications of the above-described settings are also possible.

Steps S240, S250, and 260 can also be repeated for any one or more of the other child accounts in a similar manner. It should be appreciated that there could be different settings for different individual child devices or groups of child devices, including but not limited to different levels of difficulty (e.g., easy, medium, hard), different topics/subject matter/categories (e.g., math, science, etc.), different scoring thresholds, different time limits, etc., depending on different ages, abilities, comprehension levels, specific learning needs, different rewards levels, or the like. This way, method 200 provides parents with the ability to custom tailor system 100 as appropriate for their own children or specific learning needs of each individual child.

FIG. 6 illustrates a flowchart of a method 300 for providing network monitoring and a captive learning portal from the perspective of child device 40 of system 100, according to some example embodiments. Also refer to the captive learning portal flow for child device 40 of FIG. 4.

Initially, gateway device 10 connects with child device 40, at step S310. This may include one or more GUI screens prompting the child for their credentials (select or enter their child ID and enter their child PIN/password). As mentioned above with reference to FIGS. 1, 3 and 5, a parent may have previously performed initial setup of the system 100 for use in their home network, such as by registering their child device 40 and child credentials (IDs and PINs/passwords) with associated child accounts and by configuring various parental control settings using their parent device 30.

At step S320, gateway device 10 communicates with authentication server 20a to verify child account associated with child credentials, and allocate a first time limit to said child account. In response to successful verification of child credentials by authentication server 20a, gateway device 10 receives an authentication token issued by authentication server 20a, and gateway device 10 grants access to Internet 5 for child device 40 using the token, at step S330.

Gateway device 10 then determines whether the time limit allocated to the child account has been reached, at step S340. While the time limit for accessing the Internet has not yet expired (“No” at S340), the gateway device can update the amount of time used and/or remaining at step S345, and continue monitoring child device 40. Upon said first time limit allocated to said child account being reached (“Yes” at S340), gateway device 10 blocks access to Internet for child device 40, at step S350. Gateway device 10 communicates with learning management server 20b to retrieve a quiz or task at step S360, and gateway device 10 communicates with child device 40 to present said quiz or task at step S370.

In response to results of said quiz reaching a threshold passing score or said task being completed, at step S380, gateway device 10 communicates with authentication server 20a to allocate a second time limit to said child account (step S320) and grants access to Internet for child device 40 (step S330) until said second time limit expires (steps S340-S350).

In some example embodiments, gateway device 10 communicates with learning management server 20b to determine whether the results of said quiz have reached or exceeded the threshold passing score, or whether the task has been completed. In some other example embodiments, gateway device 10 may be configured to make this determination itself for each quiz or task (e.g., without an additional communication exchange with learning management server 20b). In yet some other example embodiments, gateway device 10 may communicate with parent device 30 to determine whether the child has in fact completed the given task successfully (e.g., to confirm child has actually performed the indicated chore(s) needed to gain more Internet access time). Further still, in the case of tasks in which computerized confirmation of completion would be difficult or manual confirmation by parents would be inconvenient, the task completion check may simply be trust-based (honor system), whereby the child confirms completion of the task on their child device 40 after successfully performing the given chore (and optionally displaying a “warning” on child device 40 indicating that there may be consequences for lying or incomplete tasks, such as reduced Internet time or loss of use of the child devices, if the parent later discovers that the chore was not actually performed or was performed improperly by the child, for example).

In an optional step S390, after the passing/completion determination is made at step S380 above (whether such determination is made by gateway device 10 itself, or by communicating with learning management server 20b or parent device 30, or other trust-based task completion check), gateway device 10 may communicate with one or both of servers 20a, 20b to provide various updates to the system based on said results of said quiz or completion of said task, including but not limited to recording test results, monitoring Internet activity logs, updating leaderboards, adding more time to the child account, editing databases, or combinations thereof. In some example embodiments, learning management server 20b may communicate directly with authentication server 20a to provide updates, such as allocating additional time to the child account when that child has successfully passed the quiz or completed the task.

At this point, upon said second time limit being reached (step S340) and gateway device blocking access to Internet for child device (step S350), the process may return to steps S360-S380, where gateway device 10 communicates with learning management server 20b to retrieve another quiz or task (S360), communicates with child device 40 to present said other quiz or task (S370), and determines whether the threshold passing score for the other quiz is reached or the other task has been completed successfully (S380).

In some example embodiments, certain steps of the above-described process can be repeated multiple times without limitation throughout a given time period. However, in some other example embodiments, parent device 30 may be used to setup daily, weekly, monthly, etc. total Internet access time limits on a per child account basis. Therefore, in a variation of the above-described process, there may be a further determination made (e.g., by the gateway device or the authentication server) regarding whether a child account has reached its maximum daily/weekly/monthly allotment of total Internet access time. If the child account has not yet reached its maximum total Internet access time limit, the process of administering additional quizzes or tasks can continue as described above. However, if the child account has reached its maximum total Internet access time limit for the given time period (e.g., day/week/month), gateway device 10 may continue to block access to the Internet for child device 40 associated with said child account for the remainder of the given time period and display a corresponding notification. In this case, the time limits will eventually be reset automatically for the next time period (day/week/month), and the above-described process can then be repeated for the next time period in the same manner.

According to various example embodiments described above, the present invention provides an intermittent learning system and an easier way for parents to manage their children's time online without having to physically take away or deactivate devices from the Internet. System 100, via the functions of gateway device 10 and the server 20 in particular, provide a mechanism that can limit and allocate more time usage for accessing the Internet or specific websites or applications to a child device based on completing quizzes or tasks. The above-described system includes a built-in captive learning portal which gives the child the ability to unlock further Internet usage time themselves by successfully completing various quizzes or tasks, and which allow parents to automatically lock and unlock Internet access for children based on pre-determined variables to allow further access, which is much more convenient than conventional methods that require parents to manually block and unblock each child device on a regular basis. Additional developments within the scope of the present invention described herein may include, but are not limited to, further development of the learning management system, improvements for child device management and Internet access time management settings, improvements to graphical user interfaces, and/or adding enhanced functionality to different types of quizzes or tasks.

Having described the exemplary system 100 and corresponding exemplary methods 200 and 300 for implementing the network monitoring and captive learning portal processes set forth above among other features, an exemplary computer environment for implementing the described design and execution is presented next.

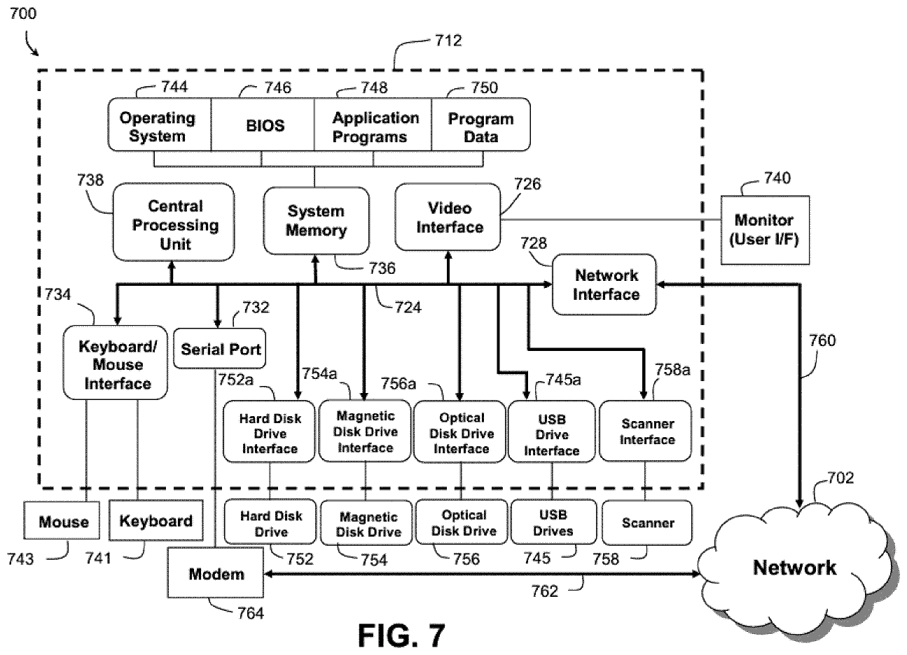

FIG. 7 shows the components of an exemplary computing environment 700 that may be used to implement any of the methods and processing thus far described. The following description of computers also applies to the local gateway device 10, one or more servers 20 (authentication server 20a and learning management server 20b), and the various user computing devices (e.g., parent device(s) 30, child device(s) 40) for implementing system 100 and methods 200 and 300 as described above with reference to FIGS. 1-6. Computing environment 700 may include one or more computers 712 comprising a system bus 724 that couples a video interface 726, network interface 728, a keyboard/mouse interface 734, and a system memory 736 to a Central Processing Unit (CPU) 738. A monitor or display 740 is connected to bus 724 by video interface 726 and provides the user with a graphical user interface as described above. The graphical user interface allows the user to enter commands and information into computer 712 using an interface control that may include a keyboard 741 and a user interface selection device 743, such as a mouse, touch screen, or other pointing device. Keyboard 741 and user interface selection device are connected to bus 724 through keyboard/mouse interface 734. The display 740 and user interface selection device 743 are used in combination to form the graphical user interface which allows the user to implement at least a portion of the present invention. Other peripheral devices may be connected to the remote computer through universal serial bus (USB) drives 745 to transfer information to and from computer 712. For example, cameras and camcorders may be connected to computer 712 through serial port 732 or USB drives 745 so that data representative of a digitally represented still image, video, audio or other digital content may be downloaded to memory 736 or another memory storage device associated with computer 712 such that the digital content may be transmitted to a server (such as server 20a or 20b of FIG. 1) in accordance with the present invention.

The system memory 736 is also connected to bus 724 and may include read only memory (ROM), random access memory (RAM), an operating system 744, a basic input/output system (BIOS) 746, application programs 748 and program data 750. The computer 712 may further include a hard disk drive 752 for reading from and writing to a hard disk, a magnetic disk drive 754 for reading from and writing to a removable magnetic disk (e.g., floppy disk), and an optical disk drive 756 for reading from and writing to a removable optical disk (e.g., CD ROM or other optical media). The computer 712 may also include USB drives 745 and other types of drives for reading from and writing to flash memory devices (e.g., compact flash, memory stick/PRO and DUO, SD card, multimedia card, smart media xD card), and a scanner 758 for scanning items such as still image photographs to be downloaded to computer 712. A hard disk drive interface 752a, magnetic disk drive interface 754a, an optical drive interface 756a, a USB drive interface 745a, and a scanner interface 758a operate to connect bus 724 to hard disk drive 752, magnetic disk drive 754, optical disk drive 756, USB drive 745 and scanner 758, respectively. Each of these drive components and their associated computer-readable media may provide computer 712 with non-volatile storage of computer-readable instruction, program modules, data structures, application programs, an operating system, and other data for computer 712. In addition, it will be understood that computer 712 may also utilize other types of computer-readable media in addition to those types set forth herein, such as digital video disks, random access memory, read only memory, other types of flash memory cards, magnetic cassettes, and the like.

Computer 712 may operate in a networked environment using logical connections with network 702 (e.g., Internet 5 of FIG. 1). Network interface 728 provides a communication path 760 between bus 724 and network 702, which allows, for example, information to be communicated to a server or database for storage and allowing access to other users. The information may also be communicated from bus 724 through a communication path 762 to network 702 using serial port 732 and a modem 764. It will be appreciated that the network connections shown herein are merely exemplary, and it is within the scope of the present invention to use other types of network connections between computer 712 and network 702 including both wired and wireless connections.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirements.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A system for providing monitoring of a network and a captive learning portal, wherein the network is in communication with an Internet, wherein the network includes a parent computing device and at least one child device, the system comprising:
at least one server configured to provide an authentication system and a learning management system for the parent computing device and the child computing device; and
a gateway device configured to provide a router function and a firewall function for the network, wherein the gateway device includes a memory having computer executable instructions stored therein configured for:
connecting with the child computing device and prompting to enter child credentials associated with a child account;
communicating with the at least one server to verify the child credentials associated with the child account, and allocate a first time limit to the child account;
granting access to the Internet for the child computing device associated with the child account via the router function in response to successful verification of the child credentials; and
blocking access to the Internet for the child computing device associated with the child account via the firewall function upon the first time limit allocated to the child account being reached according to parental control settings for the child account.

2. The system according to claim 1, wherein the at least one server includes an authentication server configured to verify that the entered child credentials are associated with a valid child account by confirming a password or a PIN of the entered child credentials using a database.

3. The system according to claim 2, wherein the parental control settings include at least one of:
one or more time limits for accessing the Internet using the child computing device associated with the child account, or
one or more quiz or task settings for granting more Internet access time for the child computing device associated with the child account.

4. The system according to claim 3, wherein the at least one server includes a learning management server configured to store at least one quiz or task, and provide the at least one of the quiz or task to the child computing device via the gateway device after each of the one or more time limits expire according to the parental control settings for the child account.

5. The system according to claim 4, wherein, when the gateway device blocks access to the Internet for the child computing device associated with the child account once the first time limit has been reached, the gateway device communicates with the learning management server to retrieve the at least one quiz or task, and communicates with the child computing device to present the at least one quiz or task,
wherein in response to results of the quiz reaching a threshold passing score or the task being completed, the gateway device further communicates with the authentication server to allocate a second time limit to the child account, and grants access to the Internet for the child computing device associated with the child account until the second time limit expires.

6. The system according to claim 5, wherein the gateway device communicates with the at least one server to provide one or more updates to the system based on the results of the quiz or completion of the task, wherein the one or more updates include recording test results, monitoring Internet activity and/or application usage logs, updating scoring leaderboards, adding more time to the child account, editing databases or combinations thereof.

7. A system for providing monitoring of a network and a captive learning portal, wherein the network is in communication with and Internet, wherein the network includes a parent computing device and at least one child computing device, the system comprising:
at least one server configured to provide an authentication system and a learning management system for the parent computing device and the at least one child computing device; and
a gateway device configured to provide a router function and a firewall function for the network, wherein the gateway device includes a memory having computer executable instructions stored therein configured for:
connecting with the parent computing device and prompting to enter parent credentials associated with a parent account;
communicating with the at least one server to verify the parent credentials associated with the parent account; and
granting access to the learning management system for the parent computing device associated with the parent account via the router function in response to successful verification of the parent credentials,
wherein said access enables the parent computing device to configure or modify one or more parental control settings for a selected child account, including setting one or more time limits for accessing the Internet using the at least one child device associated with the selected child account.

8. The system according to claim 7, wherein the at least one server includes an authentication server configured to verify that the entered parent credentials are associated with a valid parent account by confirming a password or a PIN of the entered parent credentials using a database.

9. The system according to claim 8, wherein configuring or modifying the one or more parental control settings for the selected child account further includes configuring one or more quiz or task settings for granting more Internet access time for the at least one child computing device associated with the selected child account.

10. The system according to claim 9, wherein the at least one server includes a learning management server configured to store at least one quiz or task, and provide the at least one of the quiz or task to the at least one child computing device via the gateway device after each of the one or more time limits expire according to the parental control settings for the selected child account.

11. The system according to claim 10, wherein the configuring the one or more quiz or task settings for the selected child account includes one or more of:
selecting a difficulty level of the at least one quiz for the selected child account,
selecting one or more subjects, topics, or categories of the at least one quiz for the selected child account,
setting a total number of questions or problems for each of the at least one quiz for the selected child account,
setting a threshold passing score for the at least one quiz for the selected child account,
selecting at least one predefined quiz or task from one or more lists for the selected child account, wherein the one or more lists are stored by the learning management server, or
defining at least one quiz or task for the selected child account.

12. The system according to claim 11, wherein the access further enables the parent computing device to save the one or more parental control settings for the selected child account to the at least one server via the gateway device.

13. A method programmed for execution in a computing environment for providing monitoring of a network and a captive learning portal for the network including a parent computing device and at least one child computing device, wherein the network is in communication with an Internet, utilizing a processor the method comprises:
connecting with the child computing device and prompting to enter child credentials associated with a child account;
communicating with at least one server, which provides an authentication system and a learning management system for the parent computing device and the at least one child device, to verify the child credentials associated with the child account, and allocate a first time limit to the child account;
granting access to the Internet for the at least one child computing device associated with the child account via a router function of a gateway device in response to successful verification of the child credentials by the authentication system; and
blocking access to the Internet for the at least one child computing device associated with the child account via a firewall function of the gateway device upon the first time limit allocated to the child account being reached according to parental control settings for the child account.

14. The method according to claim 13, wherein the parental control settings include at least one of:
one or more time limits for accessing the Internet using the at least one child computing device associated with the child account, or
one or more quiz or task settings for granting more Internet access time for the at least one child computing device associated with the child account.

15. The method according to claim 14, wherein the at least one server includes a learning management server configured to store at least one quiz or task, and provide at least one of the quiz or task to the at least one child computing device after each of the one or more time limits expire according to the parental control settings for the child account.

16. The method according to claim 15, wherein, when access to the Internet for the at least one child computing device associated with the child account is blocked once the first time limit has been reached, the method further comprises communicating with the learning management server to retrieve a quiz or task, and communicating with the at least one child computing device to present the quiz or task,
wherein in response to results of the quiz reaching a threshold passing score or the task being completed, the method further comprises allocating a second time limit to the child account, and granting access to the Internet for the at least one child computing device associated with the child account until the second time limit expires.

17. The method according to claim 16, further comprising communicating with the at least one server to provide one or more updates to the system based on the results of the quiz or completion of the task, wherein the one or more updates include recording test results, monitoring Internet activity and/or application usage logs, updating scoring leaderboards, adding more time to the child account, editing databases or combinations thereof.

18. A method programmed for execution in a computing environment for providing monitoring of a network and a captive learning portal for the network including a parent computing device and at least one child computing device, utilizing a processor the method comprises:
connecting with the parent computing device and prompting to enter parent credentials associated with a parent account;
communicating with at least one server, which provides an authentication system and a learning management system for the parent computing device and the at least one child computing device, to verify the parent credentials associated with the parent account; and
granting access to the learning management system for the parent computing device associated with the parent account via the router function in response to successful verification of the parent credentials by the authentication system,
wherein said access enables the parent computing device to configure or modify one or more parental control settings for a selected child account, including setting one or more time limits for accessing the Internet using at least one child computing device associated with the selected child account.

19. The method according to claim 18, wherein configuring or modifying the one or more parental control settings for the selected child account further includes configuring quiz or task settings for granting more Internet access time for the at least one child computing device associated with the selected child account.

20. The method according to claim 19, wherein the at least one server includes a learning management server configured to store at least one quiz or task, and provide the at least one quiz or task to the at least one child computing device after each of the one or more time limits expire according to the parental control settings for the selected child account.

21. The method according to claim 20, wherein the configuring of the quiz or task settings for the selected child account includes one or more of:
selecting a difficulty level of the at least one quiz for the selected child account,
selecting one or more subjects, topics, or categories of the at least one quiz for the selected child account,
setting a total number of questions or problems for each of the at least one quiz for the selected child account,
setting a threshold passing score for the at least one quiz for the selected child account,
selecting at least one predefined quiz or task from one or more lists for the selected child account, wherein the one or more lists are stored by the learning management server, or
defining at least one custom quiz or task for the selected child account.

22. The method according to claim 21, wherein the access further enables the parent computing device to save the one or more parental control settings for the selected child account to the at least one server.
